(19) United States
(12) Patent Application Publication
(10) Pub. No.: US 2025/0256446 A1
(43) Pub. Date: Aug. 14, 2025

(54) RECYCLED POLYPROPYLENE COMPOSITIONS FOR BIAXIALLY ORIENTED OPAQUE FILM APPLICATIONS

(71) Applicant: Fina Technology, Inc., Houston, TX (US)

(72) Inventors: Fengkui Li, Houston, TX (US); Peng Li, Sugar Land, TX (US); Mohammad Tuhin, Houston, TX (US); Fabrice Dehais, Houston, TX (US); Theodore G. Harris, III, Houston, TX (US)

(73) Assignee: Fina Technology, Inc., Houston, TX (US)

(21) Appl. No.: 19/049,985

(22) Filed: Feb. 10, 2025

Related U.S. Application Data
(60) Provisional application No. 63/552,529, filed on Feb. 12, 2024.

(51) Int. Cl. B29C 48/00; B29C 48/08; B29C 48/36; B29K 23/00; B29K 105/00; B29K 105/26; B29L 7/00; C08K 3/26; C08L 23/12

(52) U.S. Cl. CPC B29C 48/0018; B29C 48/022; B29C 48/08; B29C 48/36; C08K 3/26; C08L 23/12; B29K 2023/10; B29K 2105/0088; B29K 2105/26; B29K 2995/0018; B29K 2995/0022; B29K 2995/0053; B29L 2007/008; C08K 2003/265; C08L 2203/16; C08L 2205/025; C08L 2207/20

(57) ABSTRACT

A method of preparing a film comprising contacting a recycled polypropylene with a cavitating agent and an optional virgin polypropylene to form a mixture; extruding the mixture to form an extrudate; and biaxially orientating the extrudate to form a biaxially oriented film.

### CROSS-REFERENCE TO RELATED APPLICATIONS

This application claims benefit of U.S. provisional patent application Ser. No. 63/552,529 filed Feb. 12, 2024 and entitled “RECYCLED POLYPROPYLENE COMPOSITIONS FOR BIAXIALLY ORIENTED OPAQUE FILM APPLICATIONS,” which is hereby incorporated herein by reference in its entirety for all purposes.

### STATEMENT REGARDING FEDERALLY SPONSORED RESEARCH OR DEVELOPMENT

Not applicable.

### TECHNICAL FIELD

The present disclosure relates generally to polypropylene compositions. More particularly, the present disclosure relates to recycled polypropylene compositions for use in film production. Still more particularly, the present disclosure relates to the production of biaxially oriented film.

### BACKGROUND

Polypropylene is a widely used plastic that has high modulus, high tensile strength, good heat resistance, and other favorable properties in the solid-state. Synthetic polymeric materials, particularly polypropylene resins, are manufactured into a variety of end-use articles ranging from medical devices to materials film packaging.

Opaque polypropylene materials are characteristically light weight, with excellent UV resistance, a pearlized appearance, and high separative function. Commercially available opaque films are generally produced on biaxially oriented polypropylene (BOPP) equipment with either calcium carbonate or polybutylene terephthalate (PBT) as cavitating agents. Recycled resins are typically not considered for clear film applications as they tend to include a high level of impurities that detract from the film aesthetics. However, opaque BOPP films which contain a significant level of additives may be an application that can utilize impurity-laden polypropylenes such as recycled resins. An ongoing need exists to extend the utility of recycled resins in different applications.

### BRIEF SUMMARY OF THE DISCLOSURE

Disclosed herein is a method of preparing a film comprising contacting a recycled polypropylene with a cavitating agent and an optional virgin polypropylene to form a mixture; extruding the mixture to form an extrudate; and biaxially orientating the extrudate to form a biaxially oriented film.

Aspects described herein comprise a combination of features and characteristics intended to address various shortcomings associated with certain prior devices, systems, and methods. The foregoing has outlined rather broadly the features and technical characteristics of the disclosed aspects in order that the detailed description that follows may be better understood. The various characteristics and features described above, as well as others, will be readily apparent to those skilled in the art upon reading the following detailed description, and by referring to the accompanying drawings. It should be appreciated that the conception and the specific aspects disclosed may be readily utilized as a basis for modifying or designing other structures for carrying out the same purposes as the disclosed aspects. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1A is a photograph of a clear film prepared from a polypropylene homopolymer.

FIG. 1B is a photograph of an opaque film prepared using a blend of a polypropylene homopolymer and 10% polylactic acid (PLA).

FIG. 1C is a photograph of an opaque film prepared using a blend of a polypropylene homopolymer and 10% polybutylene terephthalate (PBT).

FIG. 1D is a photograph of an opaque film prepared using a blend of a polypropylene homopolymer and 30% calcium carbonate.

FIG. 2A is a scanning electron microscope image of cross section of an opaque film prepared using a blend of a polypropylene homopolymer and 10% PLA.

FIG. 2B is a scanning electron microscope image of cross section of an opaque film prepared using a blend of a polypropylene homopolymer and 10% PBT.

FIG. 2C is a scanning electron microscope image of cross section of an opaque film prepared using a blend of a polypropylene homopolymer and 30% calcium carbonate.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . ” As used herein, the phrases “consist(s) of” and “consisting of” are used to refer to exclusive components of a composition, meaning only those expressly recited components are included in the composition; whereas the phrases “consist(s) essentially of” and “consisting essentially of” are used to refer to the primary components of a composition, meaning that only small or trace amounts of components other than the expressly recited components (e.g., impurities, byproducts, etc.) may be included in the composition. For example, a composition consisting of X and Y refers to a composition that only includes X and Y, and thus, does not include any other components; and a composition consisting essentially of X and Y refers to a composition that primarily comprises X and Y, but may include small or trace amounts of components other than X and Y. In embodiments described herein, any such small or trace amounts of components other than those expressly recited following the phrase “consist(s) essentially of” or “consisting essentially of” preferably represent less than 5.0 wt % of the composition, more preferably less than 4.0 wt % of the composition, even more preferably less than 3.0 wt % of the composition, and still more preferably less than 1.0 wt % of the composition. Use of broader terms such as comprises, includes, having, etc. should be understood to provide support for narrower terms such as consisting of, consisting essentially of, comprised substantially of, etc. Use of the term “optionally” with respect to any element of a claim is intended to mean that the subject element is required, or alternatively, is not required. Both alternatives are intended to be within the scope of the claim. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

Disclosed herein are polypropylene compositions for use in the production of opaque BOPP films. Polypropylene compositions for use in the production of opaque BOPP films are herein referred to as compositions for opaque BOPP films and designated COB. In one or more aspects, the COB comprises a recycled polypropylene resin or a combination of a virgin polypropylene resin and a recycled polypropylene resin.

In one or more aspects, a recycled polypropylene resin for use in the COB comprises a polypropylene homopolymer, a polypropylene impact copolymer, a polypropylene random copolymer or combinations thereof. The term “polypropylene impact copolymer” refers to thermoplastic resins produced through the polymerization of propylene and ethylene characterized by a heterophasic amorphous structure inside a semi-crystalline polypropylene homopolymer matrix. The term “polypropylene random copolymer” refers to thermoplastic resins produced through the polymerization of propylene, with ethylene or butene bonds introduced in the polymer chain.

In one or more aspects, a recycled polypropylene for use in the COB is recovered from recycled polymer waste. Herein the term “recycled polymer waste” is used to indicate a polymer material recovered from either post-consumer waste or post-industrial waste, as opposed to virgin polymers. In one or more aspects, the recycled polypropylene is a post-consumer recycled resin or PCR. In one or more aspects, the recycled polypropylene is a post-industrial recycled resin or PIR. PCR is obtained from objects having completed at least a first use cycle (or life cycle), i.e. having already served a first purpose, while PIR refers to a resin obtained from manufacturing scrap, which has not normally reached a consumer.

A polypropylene suitable for use in the present disclosure (recycled or virgin) may have been prepared using any suitable catalyst (e.g., Ziegler Natta, metallocene, etc.). It is to be understood that a recycled polypropylene may comprise polypropylene sourced from any number of sources and consequently may contain polypropylene prepared with any number of differing catalysts. For example, the recycled polypropylene may contain a combination of Ziegler Natta catalyzed resin and metallocene catalyzed resin.

In one or more aspects, a recycled polypropylene for use in the present disclosure is a Food and Drug Administration (FDA) compliant resin. Herein “FDA compliant” means that the resin meets all of the FDA's guidelines for safe, direct contact with food or “food grade.” For example, FDA approved resin plastics in general do not contain any harmful substances that could pose health risks to humans when in contact with food, do not have the potential to release harmful substances when exposed to heat, light, or other environmental conditions and possesses high durability and stability to ensure safety during use.

In other aspects, a recycled polypropylene for use in the present disclosure is an FDA noncompliant resin. In yet other aspects, a COB comprises both FDA compliant resin and FDA noncompliant resin. For example, the amount of FDA compliant resin in the COB may range from about 0 weight percent (wt. %) to about 100 wt. %, additionally or alternatively from about 0 wt. % to about 50 wt. %, additionally or alternatively from about 0 wt. % to about 20 wt. %. In other aspects, the COB contains noncompliant FDA resin in an amount of from about 0 wt. % to about 100 wt. %, additionally or alternatively from about 50 wt. % to about 100 wt. %, additionally or alternatively from about 80 wt. % to about 100 wt. %.

In one or more aspects, a recycled polypropylene suitable for use in this COB has a density of from about 0.890 g/cc to about 0.965 g/cc; additionally or alternatively from about 0.895 g/cc to about 0.945 g/cc; additionally or alternatively from about 0.895 g/cc to about 0.925 g/cc as determined in accordance with ASTM D1505.

In one or more aspects, a recycled polypropylene suitable for use in this disclosure has a melt flow rate of from about 1 dg/min. to about 20 dg/min., additionally or alternatively from about 1.5 dg/min. to about 10 dg/min., additionally or alternatively from about 2 dg/min to about 8 dg/min. as determined in accordance with ASTM D1238 at a temperature of 230° C. and a load of 2.16 kg.

In an aspect, a recycled polypropylene suitable for use in this disclosure is characterized by a flexural modulus, as determined in accordance with ASTM D790, of from about 100,000 pounds per square inch (psi) to about 300,000 psi; additionally or alternatively from about 150,000 psi to about 280,000 psi; additionally or alternatively from about 150,000 psi to about 250,000 psi.

In an aspect, a recycled polypropylene suitable for use in this disclosure is characterized by a tensile yield strength, as determined in accordance with ASTM D638, of from about 2,000 psi to about 6,000 psi; additionally or alternatively from about 3,000 psi to about 5,500 psi; additionally or alternatively from about 3,500 psi to about 5,000 psi.

In an aspect, a recycled polypropylene suitable for use in this disclosure is characterized by an Izod impact, as determined in accordance with ASTM D-256, of from about 0.2 ft-lb/in to about 5.0 ft-lb/in; additionally or alternatively from about 0.5 ft-lb/in to about 4.0 ft-lb/in; additionally or alternatively from about 0.5 ft-lb/in to about 3.0 ft-lb/in.

In one or more aspects, the recycled polypropylene suitable for use in the COB is characterized by a recrystallization peak of from about 70° C. to about 140° C.; additionally or alternatively from about 80° C. to about 130° C.; additionally or alternatively from about 90° C. to about 130° C.; a second peak melt ranging from about 120° C. to about 170° C.; additionally or alternatively from about 140° C. to about 170° C.; additionally or alternatively from about 150° C. to about 170° C. In one or more aspects, the recycled polypropylene is characterized by a percentage crystallinity ranging from about 20% to about 70%; additionally or alternatively from about 30% to about 65%; additionally or alternatively from about 40% to about 60%.

In one or more aspects, a recycled polypropylene resin for use in the COB has impurities (e.g., other polymers such as polyethylene, elastomers, or inorganic fillers, etc.) present in amounts ranging from about 0 wt. % to about 50 wt. %; additionally or alternatively from about 10 wt. % to about 50 wt. %; additionally or alternatively from about 20 wt. % to about 50 wt. % based on the total weight of the recycled polypropylene resin. In one or more aspects, the COB contains additives and/or impurities that were present when the recycled polypropylene was sourced. In one or more aspects, a recycled polypropylene for use in the present disclosure contains additives and/or impurities not found in a virgin resin.

The COB may optionally further comprise a virgin resin. The term “virgin” denotes newly produced materials and/or objects prior to their first use, which have not already been recycled. In one or more aspects, a virgin polypropylene resin for use in the COB is a reactor grade resin which refers to a product obtained from a polymerization reactor without further processing. In one or more aspects, the virgin resin comprises a polypropylene homopolymer. The expression “propylene homopolymer” refers to a polypropylene that consists substantially of propylene units (e.g., greater than about 95%).

In one or more aspects, an optional virgin polypropylene suitable for use in this COB has a density of from about 0.890 g/cc to about 0.920 g/cc; additionally or alternatively from about 0.895 g/cc to about 0.915 g/cc; additionally or alternatively from about 0.895 g/cc to about 0.910 g/cc as determined in accordance with ASTM D1505.

In one or more aspects, the optional virgin polypropylene is characterized by a molecular weight distribution or polydispersity index of from about 2.0 to about 15; additionally or alternatively from about 2.0 to about 12; additionally or alternatively from about 2.0 to about 8.0.

In one or more aspects, the optional virgin polypropylene is characterized by a MFR of from about 0.5 dg/min. to about 20 dg/min.; additionally or alternatively from about 0.5 dg/min. to about 10 dg/min.; additionally or alternatively from about 0.5 dg/min. to about 5 dg/min. at a temperature of 230° C. and a load of 2.16 kg.

In some aspects, the optional virgin polypropylene is characterized by a xylene soluble content of from about 0.2 wt. % to about 5.0 wt. %; additionally or alternatively from about 0.2 wt. % to about 4.0 wt. %; additionally or alternatively from about 0.2 wt. % to about 3.0 wt. % as determined in accordance with ASTM D5492.

In some aspects, the optional virgin polypropylene is characterized by a flexural modulus of from about 100 Kpsi to about 300 Kpsi; additionally or alternatively from about 150 Kpsi to about 280 Kpsi; additionally or alternatively from about 150 Kpsi to about 250 Kpsi as determined in accordance with ASTM D790-97.

In one or more aspects, the optional virgin polypropylene is characterized by a melt profile as determined by differential scanning calorimetry including; a recrystallization peak of from about 70° C. to about 140° C.; additionally or alternatively from about 80° C. to about 130° C.; additionally or alternatively from about 90° C. to about 130° C.; a second peak melt ranging from about 120° C. to about 170° C.; additionally or alternatively from about 130° C. to about 170° C.; additionally or alternatively from about 150° C. to about 170° C.; and a percentage crystallinity ranging from about 20% to about 70%; additionally or alternatively from about 30% to about 65%; additionally or alternatively from about 40% to about 60%.

In an aspect, a COB comprises a recycled polypropylene (e.g., PIR, PCR) in amounts ranging from about 0.1 wt. % to about 100 wt. %, additionally or alternatively from about 10 wt. % to about 90 wt. % or, additionally or alternatively from about 25 wt. % to about 75 wt. % based on the total weight of resin in the PP-t. In other aspects, the PP-t comprises a recycled polypropylene present in an amount of about 1 wt. %, about 2 wt. %, about 4 wt. %, about 6 wt. %, about 8 wt. %, about 10 wt. %, about 12 wt. %, about 14 wt. %, about 16 wt. %, about 18 wt. %, about 20 wt. %, about 22 wt. %, about 24 wt. %, about 26 wt. %, about 28 wt. %, about 30 wt. %, about 32 wt. %, about 34 wt. %, about 36 wt. %, about 38 wt. %, about 40 wt. %, about 42 wt. %, about 44 wt. %, about 46 wt. %, about 48 wt. %, about 50 wt. %, about 52 wt. %, about 54 wt. %, about 56 wt. %, about 58 wt. %, about 60 wt. %, about 62 wt. %, about 64 wt. %, about 66 wt. %, about 68 wt. %, about 70 wt. %, about 72 wt. %, about 74 wt. %, about 76 wt. %, about 78 wt. %, about 80 wt. %, about 82 wt. %, about 84 wt. %, about 86 wt. %, about 88 wt. %, about 90 wt. %, about 92 wt. %, about 94 wt. %, about 96 wt. %, about 98 wt. %, or about 99 wt. % based on the total weight of the VOB. In one or more aspects, the remainder of polymer in the COB comprises virgin polypropylene. In some aspects, the COB comprises 99% of a recycled polypropylene (e.g., PIR, PCR, or both). In some aspects, the COB comprises 100% of a recycled polypropylene (e.g., PIR, PCR, or both).

A COB may further comprise one or more additives to impart some user and/or process desired property to the composition and film. Nonlimiting examples of additives suitable for inclusion in the COB are colorants, cavitating agents, slip agents, antioxidants, anti-fog agents, anti-static agents, anti-block agents, fillers, moisture barrier additives, gas barrier additives, gas scavengers, neutralizers, and combinations thereof. Such additives may be used singularly or in combination in effective amounts, which may vary depending upon the property desired. In some aspects, at least a portion of the additives with the COB originate from the recycled polypropylene.

In an aspect, the COB comprises one or more cavitating agents which are also known as void-initiating additives. These void-initiating additives may be effective to form voids during the film orientation process and create a haze in the film. Nonlimiting examples of cavitating agents suitable for use in the COB include calcium carbonate, polylactic acid, polybutylene terephthalate (PBT), nylon, solid or hollow pre-formed glass spheres, metal beads or spheres, ceramic spheres, calcium carbonate, talc, chalk, or combinations thereof. In one or more aspects, the cavitating agent comprises calcium carbonate, PBT or combinations thereof. The average diameter of the cavitating agent may range from about 0.1 μm to 10 μm. In some aspects, a cavitating agent is added to the COB. Cavitating agents of the type disclosed herein may be present in the COB in amounts effective to meet one or more user and/or process goals. In another aspect, the COB excludes cavitating agents such that any cavitating agents in the COB originate from the recycled polypropylene or optional virgin polypropylene. For example, the COB may have cavitating agents present in amounts ranging from about 2 wt. % to about 30 wt. %; additionally or alternatively from about 5 wt. % to about 30 wt. %; additionally or alternatively from about 2 wt. % to about 25 wt. %; additionally or alternatively from about 2 wt. % to about 20 wt. % based on the total weight of the COB.

In one or more aspects, the COB is used to form an oriented film, alternatively a biaxially oriented film. The term “biaxially oriented” film indicates that the film has been subjected to a stretching process in machine direction (MD) and transverse direction (TD). For example, a method of preparing the film may first involve melting the COB or blending the COB with one or more cavitating agents (assuming the COB does not have any or sufficient cavitating agents) in an extruder to form a molten COB. Next, the molten COB is extruded through a slot or a die and is passed over a first roller (e.g. a chill roll stand) which may be configured to solidify the COB into a film. Then, the film may be oriented by stretching such film in the machine direction and traverse direction. The machine direction orientation is generally accomplished through the use of two sequentially disposed rollers, the second (or faster roller) operating at a speed in relation to the first slower roller corresponding to the desired orientation ratio. Machine direction orientation may alternatively be accomplished through a series of rollers with increasing speeds, sometimes with additional intermediate rollers for temperature control or other functions. After machine direction orientation, the film may be cooled, pre-heated and passed into a lateral orientation section. The lateral orientation section may include for example, a tenter frame mechanism where film is stretched in the transverse direction. Annealing or additional processing may follow such orientation. The resulting opaque COB film may be further trimmed and rolled for transport or storage. In one or more aspects, the COB film has a thickness of from about 0.1 mils to about 20 mils; additionally or alternatively from about 0.5 mils to about 15 mils; additionally or alternatively from about 0.5 mils to 10 mils where a mil is one thousandth of an inch.

In one or more aspects, a biaxially oriented film formed from a COB of the present disclosure may have a haze of from about 50% to about 100%, alternatively from about 70% to about 100%, or alternatively from about 90% to about 100%, as determined in accordance with ASTM D1003-00. Herein the term “haze” refers to the percentage of incident light scattered by more than 2.5° through the plastic specimen.

In one or more aspects, a biaxially oriented film formed from the COB is characterized by a gloss at 45° of from about 10 to about 80; additionally or alternatively from about 15 to about 60; additionally or alternatively from about 20 to about 40 as determined in accordance with ASTM D1003.

In an aspect, a biaxially oriented film formed from the COB may have a tensile yield strength in the machine direction ranging from about 4000 psi to about 10000 psi; additionally or alternatively from about 5000 psi to about 9500 psi; additionally or alternatively from about 5500 psi to about 9000 psi as determined in accordance with ASTM 882.

In an aspect, a biaxially oriented film formed from the COB has a tensile yield elongation in the machine direction ranging from about 10% to about 80%; additionally or alternatively from about 20% to about 60%, additionally or alternatively from about 30% to about % as determined in accordance with ASTM 882.

In an aspect, a biaxially oriented film formed from the COB has a tensile break strength in the machine direction ranging from about 4000 psi to about 10000 psi; additionally or alternatively from about 5000 psi to about 9500 psi; additionally or alternatively from about 5500 psi to about 9000 psi as determined in accordance with ASTM 882.

In an aspect, a biaxially oriented film formed from the COB has a tensile break elongation in the machine direction ranging from about 10% to about 80%; additionally or alternatively from about 20% to about 60%; additionally or alternatively from about 30% to about 60% as determined by ASTM 882.

In an aspect, a biaxially oriented film formed from the COB has a tensile modulus 1% secant in the machine direction ranging from about 100 kpsi to about 300 kpsi; additionally or alternatively from about 100 kpsi to about 200 kpsi; additionally or alternatively from about 100 kpsi to about 150 kpsi as determined in accordance with ASTM 882.

In an aspect, a biaxially oriented film formed from the COB has a tensile yield strength in the transverse direction ranging from about 4000 psi to about 10000 psi; additionally or alternatively from about 5000 psi to about 9500 psi, additionally or alternatively from about 5500 psi to about 9000 psi as determined in accordance with ASTM 882.

In an aspect, a biaxially oriented film formed from the COB has a tensile yield elongation in the transverse direction ranging from about 10% to about 80%, additionally or alternatively from about 20% to about 60%; additionally or alternatively from about 30% to about 50% as determined in accordance with ASTM 882.

In an aspect, a biaxially oriented film formed from the COB has a tensile break strength in the transverse direction ranging from about 4000 psi to about 10000 psi; additionally or alternatively from about 5000 psi to about 9500 psi, additionally or alternatively from about 5500 psi to about 9500 psi as determined in accordance with ASTM 882.

In an aspect, a biaxially oriented film formed from the COB has a tensile break elongation in the transverse direction ranging from about 10% to about 80%; additionally or alternatively from about 20% to about 60%; additionally or alternatively from about 30% to about 50% as determined by ASTM 882.

In an aspect, a biaxially oriented film formed from the COB has a tensile modulus 1% secant in the transverse direction ranging from about 100 kpsi to about 300 kpsi; additionally or alternatively from about 100 kpsi to about 200 kpsi; additionally or alternatively from about 100 kpsi to about 150 kpsi as determined by ASTM 882.

Disclosed herein are recycled polypropylene compounds which in some aspects involve the combinations of (i) a virgin resin and (ii) and a recycled resin sourced from a PIR or PCR, which can be used in the formation of BOPP films. Many commercially available PIR or PCR resins contain small amounts of PE or other contaminants, making them less ideal for clear film applications where clarity and low gels are essential. However, BOPP opaque film formulations are usually formulated with high levels of cavitating agents, which are much less sensitive to “contaminants” or “impurities” in materials containing recycled polypropylene.

Films formed from COBs of this disclosure may be converted to various end-use articles. Nonlimiting examples of such end use articles laminate flooring compositions, polymeric foam substrate, decorative surfaces (e.g., crown molding, etc.), weatherable outdoor materials, point-of-purchase signs and displays, housewares and consumer goods, cosmetics packaging, outdoor replacement materials, lids and containers, appliances, utensils, flower overwrapping, cigarette overwrapping, CD overwrapping, shrinkable films, release films, twist films, mat films, non-electrical capacitor films, food packaging, flexible packaging, candy bar wrappers, hygiene articles, textiles, stationery goods, photo albums, envelopes, windows, catalogues, manuals, maps, audio/video cassettes, industrial tapes, carton boxes, restaurant menus, and electrical articles.

### Additional Disclosure

A first aspect which is a method of preparing a film comprising contacting a recycled propylene with a cavitating agent and an optional virgin polypropylene to form a mixture; extruding the mixture to form an extrudate; and biaxially orientating the extrudate to form a biaxially oriented film.

A second aspect which is the method of the first aspect wherein the recycled polypropylene is sourced from post-consumer recycled resin, post-industrial recycled resin or combinations thereof.

A third aspect which is the method of any of the first through second aspects wherein the recycled polypropylene has a density of from about 0.890 g/cc to about 0.965 g/cc.

A fourth aspect which is the method of any of the first through third aspects wherein the recycled polypropylene has a melt flow rate of from about 1 g/10 min. to about 20 g/10 min.

A fifth aspect which is the method of any of the first through fourth aspects wherein the recycled polypropylene comprises an FDA noncompliant resin.

A sixth aspect which is the method of any of the first through fifth aspects wherein the recycled polypropylene has a flexural modulus of from about 100,000 psi to about 300,000 psi as determined in accordance with ASTM D790.

A seventh aspect which is the method of any of the first through sixth aspects wherein the recycled polypropylene has a tensile yield strength of from about 2000 psi to about 6000 psi as determined in accordance with ASTM D638.

An eighth aspect which is the method of any of the first through seventh aspects wherein the recycled polypropylene has an Izod impact of from about 0.2 ft-lb/in to about 5.0 ft-lb/in as determined in accordance with ASTM D-256.

A ninth aspect which is the method of any of the first through eighth aspects wherein the optional virgin polypropylene has a polydispersity index of from about 2 to about 15.

A tenth aspect which is the method of any of the first through ninth aspects wherein the optional virgin polypropylene has is characterized by a density of from about 0.890 g/cc to about 0.920 g/cc.

An eleventh aspect which is the method of any of the first through tenth aspects wherein the optional virgin polypropylene has a MFR of from about 0.5 dg/min to about 20 dg/min.

A twelfth aspect which is the method of any of the first through eleventh aspects wherein the optional virgin polypropylene has a xylene soluble content of from about 0.2 wt. % to about 5.0 wt. %.

A thirteenth aspect which is the method of any of the first through twelfth aspects wherein the mixture comprises a recycled polypropylene (in amounts ranging from about 0.1 wt. % to about 100 wt. % based on the total weight of the mixture).

A fourteenth aspect which is the method of any of the first through thirteenth aspects wherein the cavitating agent comprises polylactic acid, polybutylene terephthalate, nylon, solid or hollow pre-formed glass spheres, metal beads or spheres, ceramic spheres, calcium carbonate, talc, chalk, or combinations thereof.

A fifteenth aspect which is the method of any of the first through fourteenth aspects wherein the cavitating agent comprises calcium carbonate.

A sixteenth aspect which is the method of any of the first through fifteenth aspects wherein the cavitating agent is present in an amount of from about 2 wt. % to about 30 wt. %.

A seventeenth aspect which is the method of any of the first through sixteenth aspects wherein the film has a haze of from about 50% to about 100%.

An eighteenth aspect which is the method of any of the first through seventeenth aspects wherein the film has a gloss at 45° of from about 10 to about 80.

A nineteenth aspect which is the method of any of the first through eighteenth aspects wherein the film has a tensile yield strength in the machine direction ranging from about 4,000 psi to about 10,000 psi.

A twentieth aspect which is the method of any of the first through nineteenth aspects wherein the film has a tensile yield elongation in the machine direction ranging from about 10% to about 80%.

A twenty-first aspect which is the method of any of the first through twentieth aspects wherein the film has a tensile break strength in the machine direction ranging from about 4,000 psi to about 10,000 psi.

A twenty-second aspect which is the method of any of the first through twenty-first aspects the film has a tensile modulus 1% secant in the machine direction ranging from about 100 kpsi to about 300 kpsi.

A twenty-third aspect which is the method of any of the first through twenty-second aspects wherein the film has a tensile break strength in the transverse direction ranging from about 4,000 psi to about 10,000 psi.

A twenty-fourth aspect which is the method of any of the first through twenty-third aspects wherein the film has a tensile modulus 1% secant in the transverse direction ranging from about 100 kpsi to about 300 kpsi.

### EXAMPLES

The aspects having been generally described, the following examples are given as particular aspects of the disclosure and to demonstrate the practice and advantages thereof. It is understood that the examples are given by way of illustration and are not intended to limit the specification of the claims in any manner.

### Example 1

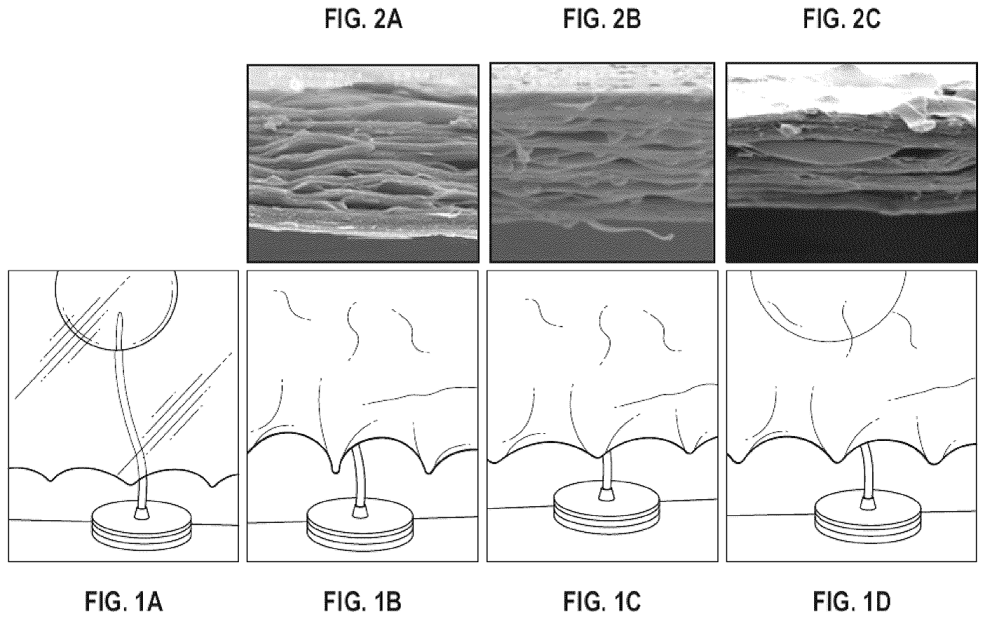

FIGS. 1A, 1B, 1C and 1D are photographs of clear and opaque films prepared from a polypropylene homopolymer (PP), a blend of PP and 10% PLA, a blend of PP and 10% PBT, a blend of PP and 30% calcium carbonate, respectively. FIGS. 2A, 2B and 2C are cross-sectional scanning electron microscope images of opaque films prepared from a blend of PP and 10% PLA, a blend of PP and 10% PBT, and a blend of PP and 30% calcium carbonate, respectively.

Several rPP hybrid compounds were produced with 3720 WZ and different PCRs, including Nuvada 400, NUVADA 500, and BANYAN PCR. 3270 WZ is a 2 MFR homopolymer PP commercially available from TotalEnergies. Both NUVADA 400 and NUVADA 500 PCR are composed of significant amounts of PE contamination (up to 40%). Calcium carbonate (CaCO₃), a standard cavitating agent in the polypropylene opaque film industry, was used in the formulation. The specific formulations used in film preparation are presented in Table 1. Opaque biaxially oriented polypropylene (BOPP) films were successfully produced from both virgin and hybrid compounds under the same processing conditions that included a processing temperature window ranging from 140° C. to 165° C.

TABLE 1

| FORMULATION | REFERENCE | 2 | 3 | 4 |
|---|---|---|---|---|
| BASE RESIN | 80% | 56% | 56% | 56% |
| NUVIDA 400 | 0 | 24% | 0 | 0 |
| PCR | | | | |
| NUVIDA 500 | 0 | 0 | 24% | 0 |
| PCR | | | | |
| BANYAN PCR | 0 | 0 | 0 | 24% |
| CaCO₃ | 20% | 20% | 20% | 20% |

All compounds were used to produce 16-mil sheets on a mini-coex line, which were then biaxially oriented into BOPP films on the Bruckner machine. All of the films exhibited desirable haze results of approximately 100%. Additionally, compared to the virgin resin-based opaque films, the hybrid rPP films according to this disclosure Samples 2, 3 and 4 showed comparable mechanical performance in terms of puncture resistance, tensile strength, and film modulus. The results indicated that low-cost PCRs with a high level of contaminants may have good potential for BOPP opaque film applications. The results of this testing are presented in Table 2.

TABLE 2

| PROPERTY | REFERENCE | 2 | 3 | 4 |
|---|---|---|---|---|
| Film thickness (mil) | 2.2 | 2.3 | 2.4 | 2.4 |
| Haze (%) | 100 | 100 | 100 | 100 |
| Gloss (%) | 40 | 23 | 27 | 25 |
| Tensile Yield | 7981 | 7464 | 8056 | 8530 |
| Strength MD (psi) | | | | |
| Tensile Yield | 31 | 39 | 38 | 41 |
| Elongation MD (%) | | | | |
| Tensile Break | 7911 | 7427 | 7996 | 8464 |
| Strength MD (psi) | | | | |
| Tensile Break | 31.2 | 31.6 | 38.9 | 41.3 |
| Elongation MD (%) | | | | |
| Tensile Modulus MD | 107 | 116 | 124 | 125 |
| 1% Secant (kpsi) | | | | |
| Tensile Yield | 6481 | 6148 | 6852 | 8565 |
| Strength TD (psi) | | | | |
| Tensile Yield | 31 | 34 | 34 | 43 |
| Elongation TD (%) | | | | |
| Tensile Break | 6424 | 6113 | 6796 | 8520 |
| Strength TD (psi) | | | | |
| Tensile Break | 31.2 | 34.5 | 34.4 | 43.9 |
| Elongation TD (%) | | | | |
| Tensile Modulus TD | 121 | 115 | 118 | 131 |
| 1% Secant (kpsi) | | | | |
| Puncture resistance- | 5.42 | 5.05 | 5.60 | 5.63 |
| Max Load (lbf) | | | | |
| Puncture resistance- | 0.45 | 0.44 | 0.48 | 0.47 |
| Energy (In-lb) | | | | |

### Example 2

It was investigated whether incorporation of small amounts of VISTAMAXX additive modifiers could improve the dispersion of the cavitating agents CaCO₃ in opaque BOPP films. VISTAMAXX additive is a semi-crystalline polyolefin performance polymer additive that is used to improve the properties of other materials and is commercially available from ExxonMobil Chemical. A mix of 5% VISTAMAXX and 20% CaCO₃ was compounded with both virgin 3270, and 3270/PCR hybrids containing 24% PCR, respectively. The VISTAMAXX resins used in this study were 6902 (about 100 MFR) and 7020BF (about 20 MFR). The specific formulations are presented in Table 3.

TABLE 3

| | VIRGIN PP | | | HYBRID rPP | | |
|---|---|---|---|---|---|---|
| | SYSTEM (%) | | | SYSTEM (%) | | |
| FORMULATION | VPP-5 | VPP-6 | VPP-7 | 8 | 9 | 10 |
| BASE RESIN | 80 | 75 | 75 | 50 | 45 | 45 |
| BANYAN PCR | 0 | 0 | 0 | 30 | 30 | 30 |
| CaCO₃ | 20 | 20 | 20 | 20 | 20 | 20 |
| VISTAMAX 6902 | 0 | 5 | 0 | 0 | 5 | 0 |
| VISTAMAX 7020BF | 20% | 0 | 5 | 0 | 0 | 5 |

Preliminary results indicated that films containing VISTAMAXX 6902 appeared to be glossy and free of specks, likely due to improved CaCO₃ dispersion. VISTAMAXX 7020BF was also found to produce BOPP opaque films with comparable properties when used in rPP hybrids. More detailed information is provided in Table 4.

TABLE 4

| | VPP- | VPP- | VPP- | | | |
|---|---|---|---|---|---|---|
| PROPERTY | 5 | 6 | 7 | -8 | 9 | 10 |
| Film thickness | 2.5 | 2.6 | 2.5 | 2.5 | 2.6 | 2.6 |
| (mil) | | | | | | |
| Haze (%) | 99.6 | 99.1 | 99 | 97.7 | 97.5 | 97.5 |
| Gloss 45° | 41.1 | 40.5 | 46.1 | 37.8 | 32.9 | 34.5 |
| Tensile Yield | 7077 | 7223 | 6744 | 6106 | 7232 | 7161 |
| Strength MD | | | | | | |
| (psi) | | | | | | |
| Tensile Yield | 34.2 | 34.5 | 33.6 | 34.7 | 45.5 | 38.2 |
| Elongation MD | | | | | | |
| (%) | | | | | | |
| Tensile Break | 7042 | 7183 | 6700 | 6064 | 7168 | 7121 |
| Strength MD | | | | | | |
| (psi) | | | | | | |
| Tensile Break | 34.2 | 34.5 | 33.6 | 34.6 | 45.5 | 38.2 |
| Elongation MD | | | | | | |
| (%) | | | | | | |
| Tensile | 113 | 105 | 100 | 97 | 97 | 101 |
| Modulus MD | | | | | | |
| 1% Secant | | | | | | |
| (kpsi) | | | | | | |
| Tensile Yield | 6692 | 7514 | 6138 | 6634 | 7360 | 7505 |
| Strength TD | | | | | | |
| (psi) | | | | | | |
| Tensile Yield | 30.15 | 33.86 | 21.04 | 33.21 | 45.22 | 38.53 |
| Elongation TD | | | | | | |
| (%) | | | | | | |
| Tensile Break | 6645 | 7471 | 6104 | 6570 | 7304 | 7469 |
| Strength TD | | | | | | |
| (psi) | | | | | | |
| Tensile Break | 30.1 | 33.9 | 21 | 33.2 | 45.2 | 38..5 |
| Elongation TD | | | | | | |
| (%) | | | | | | |
| Tensile | 113 | 108 | 106 | 102 | 95 | 98 |
| Modulus TD | | | | | | |
| 1% Secant | | | | | | |
| (kpsi) | | | | | | |

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A method of preparing a film, the method comprising:
contacting a recycled propylene with a cavitating agent and an optional virgin polypropylene to form a mixture;
extruding the mixture to form an extrudate; and
biaxially orientating the extrudate to form a biaxially oriented film.

2. The method of claim 1, wherein the recycled polypropylene is sourced from post-consumer recycled resin, post-industrial recycled resin or combinations thereof.

3. The method of claim 1, wherein the recycled polypropylene has a density of from about 0.890 g/cc to about 0.965 g/cc.

4. The method of claim 1, wherein the recycled polypropylene has a melt flow rate of from about 1 g/10 min. to about 20 g/10 min.

5. The method of claim 1, wherein the recycled polypropylene comprises an FDA noncompliant resin.

6. The method of claim 1, wherein the recycled polypropylene has a flexural modulus of from about 100,000 psi to about 300,000 psi as determined in accordance with ASTM D790.

7. The method of claim 1, wherein the recycled polypropylene has a tensile yield strength of from about 2000 psi to about 6000 psi as determined in accordance with ASTM D638.

8. The method of claim 1, wherein the recycled polypropylene has an Izod impact of from about 0.2 ft-lb/in to about 5.0 ft-lb/in as determined in accordance with ASTM D-256.

9. The method of claim 1, wherein the optional virgin polypropylene has a polydispersity index of from about 2 to about 15.

10. The method of claim 1, wherein the optional virgin polypropylene has is characterized by a density of from about 0.890 g/cc to about 0.920 g/cc.

11. The method of claim 1, wherein the optional virgin polypropylene has a MFR of from about 0.5 dg/min to about 20 dg/min.

12. The method of claim 1, wherein the optional virgin polypropylene has a xylene soluble content of from about 0.2 wt. % to about 5.0 wt. %.

13. The method of claim 1, wherein the mixture comprises a recycled polypropylene (in amounts ranging from about 0.1 wt. % to about 100 wt. % based on the total weight of the mixture.

14. The method of claim 1, wherein the cavitating agent comprises polylactic acid, polybutylene terephthalate, nylon, solid or hollow pre-formed glass spheres, metal beads or spheres, ceramic spheres, calcium carbonate, talc, chalk, or combinations thereof.

15. The method of claim 1, wherein the cavitating agent comprises calcium carbonate.

16. The method of claim 1, wherein the cavitating agent is present in an amount of from about 2 wt. % to about 30 wt. %.

17. The method of claim 1, wherein the film has a haze of from about 50% to about 100%.

18. The method of claim 1 wherein the film has a gloss at 45° of from about 10 to about 80.

19. The method of claim 1, wherein the film has a tensile yield strength in the machine direction ranging from about 4,000 psi to about 10,000 psi.

20. The method of claim 1, wherein the film has a tensile yield elongation in the machine direction ranging from about 10% to about 80%.

21. The method of claim 1, wherein the film has a tensile break strength in the machine direction ranging from about 4,000 psi to about 10,000 psi.

22. The method of claim 1, wherein the film has a tensile modulus 1% secant in the machine direction ranging from about 100 kpsi to about 300 kpsi.

23. The method of claim 1, wherein the film has a tensile break strength in the transverse direction ranging from about 4,000 psi to about 10,000 psi.

24. The method of claim 1, wherein the film has a tensile modulus 1% secant in the transverse direction ranging from about 100 kpsi to about 300 kpsi.
